(19) United States
(12) Patent Application Publication
(10) Pub. No.: US 2025/0335239 A1
(43) Pub. Date: Oct. 30, 2025

(54) FEDERATED ENGINE EXECUTION

(71) Applicant: SAP SE, Walldorf (DE)

(72) Inventors: Daniel BOS, Beijing (CN); Peter SCHOENAU, Untergruppenbach (DE); Tobias KARPSTEIN, Eschelbronn (DE)

(21) Appl. No.: 18/650,237

(22) Filed: Apr. 30, 2024

(51) Int. Cl. G06F 9/48

(52) U.S. Cl. CPC G06F 9/485

(57) ABSTRACT

System, method, and various embodiments for a federated execution system are described herein. An embodiment operates by determining that an managed flow for a transfer of data from a source to a target is managed by an orchestrator system that communicates with each of a plurality of data engines during the transfer. Flow metadata is generated for each of the plurality of data engines. Each of the plurality of data engines is configured with a flow component configured to process the flow metadata and provide output from the respective data engine to the component data engine in accordance with the flow metadata. A component flow for the transfer of data from the source to the target is initiated.

### BACKGROUND

Traditional flow-based data processing systems usually use a central orchestrator to manage and control the flow of data between different components. The orchestrator will trigger the execution of individual steps based on back-and-forth communications with each of the components. However, this back-and-forth communications between the orchestrator the various components of a processing system consumes a great deal of computing bandwidth and resources which makes processing more expensive, slows system processing, and reduces overall system throughput.

### BRIEF DESCRIPTION OF THE DRAWINGS

The accompanying drawings are incorporated herein and form a part of the specification.

FIG. 1 is a block diagram illustrating example functionality for a federated execution system (FES), according to some embodiments.

FIG. 2 is a flowchart illustrating example operations for providing a federated execution system (FES), according to some embodiments.

FIG. 3 is example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing a federated execution system.

Traditional flow-based data processing systems usually use a central orchestrator to manage and control the flow of data between different components. The orchestrator will trigger the execution of individual steps based on back-and-forth communications with each of the components. However, this back-and-forth communications between the orchestrator the various components of a processing system consumes a great deal of computing bandwidth and resources which makes processing more expensive, slows system processing, and reduces overall system throughput.

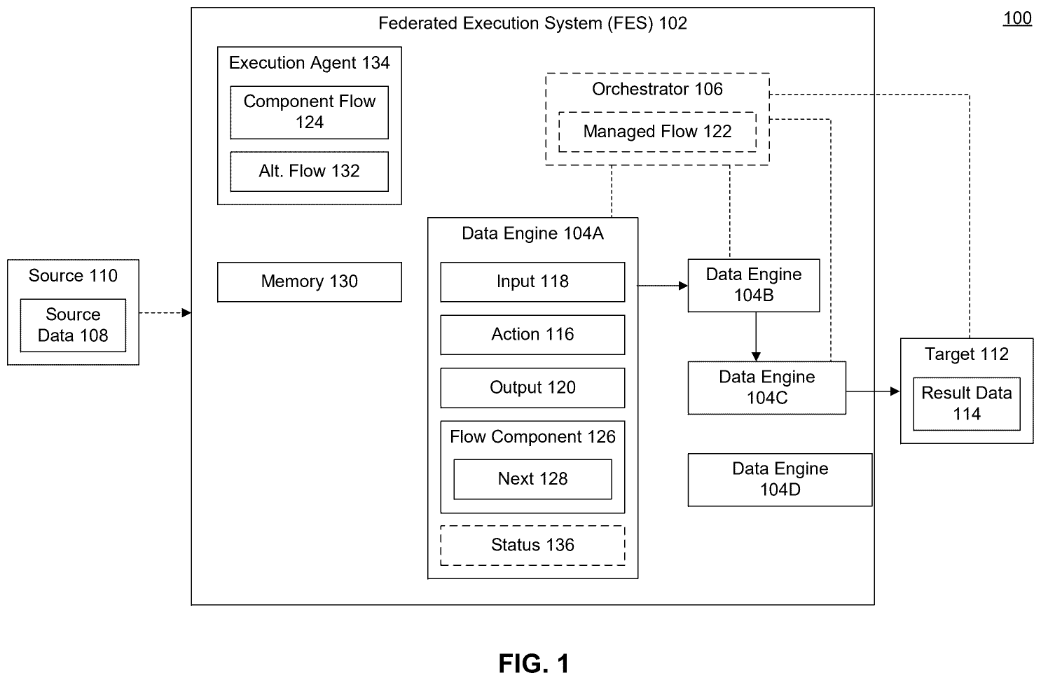

FIG. 1 is a block diagram 100 illustrating example functionality for a federated execution system (FES) 102, according to some embodiments. FES 102 may allow for the expedited processing of data using fewer computing resources and less bandwidth relative to a conventional system. FES 102 allows for direct communications between various data engines 104A-D that perform various data processing tasks, without the use of an orchestrator 106 to manage the communications or data processing. FES 102 may reduce the computing overhead and communications bandwidth that would otherwise be required when using an orchestrator 106 to manage data processing and/or data movement operations amongst the data engines 104.

In some embodiments, FES 102 may provide for the movement and transformation of source data 108 from a source 110 to a target 112 as result data 114. Source 110 may include any computing system, data storage mechanism, database, memory, network, or one or more devices storing source data 108. Source data 108 may include any data that is stored at source 110 that is to be moved, copied, transformed and/or otherwise transferred to target 112 as result data 114.

Target 112 may include any computing system, data storage mechanism, database, memory, network, or one or more devices that have requested or are otherwise configured to receive and store or process result data 114. Result data 114 may include the source data 108 after one or more data transformations are performed on source data 108 by one or more of the data engines 104A-D.

Data engines 104A-D, herein referred to generally as data engine 104 or data engines 104, may include computing devices, programs, or other data processing systems that are configured to perform some action 116 with regards to data. The action 116 may include any action such as moving the data, adding data, removing data, updating data, modifying data, or otherwise transforming or applying one or more data transformations to the data (e.g., such as changing the data type).

In some embodiments, an orchestrator 106 may be used to manage the operations of the data engines 104. The orchestrator 106 may include a device, program, or computing system that tracks and initiates the movement and transformation of data across the data engines 104. For example, orchestrator 106 may signal data engine 104A to begin the process and retrieve the source data 108, and once data engine 104A has retrieved the data (and optionally performed another action 116), data engine 104A may send the retrieved and/or transformed data in a communication to orchestrator 106. The communication may indicate that the action 116 and processing by data engine 104A has been completed. Orchestrator 106 may then send the data received from data engine 104A to data engine 104B.

Upon receiving a communication from orchestrator 106, data engine 104B may then perform its own action(s) 116 on the data, and provide the resultant data back to orchestrator 106. Orchestrator 106 may then send the data received from data engine 104B to data engine 104C. And this process may repeat and continue until orchestrator 106 provides the result data 114 to target 112.

The challenge that arises with using the orchestrator 106 is that there is a high communications and computing bandwidth cost in the back-and-forth communications and transfer of data between orchestrator 106 and the various data engines 104. These back-and-forth communications and data transfers consume bandwidth and processing resources which cause network traffic and congestion, reducing system throughput, and increasing the time and resources required to transfer and transform source data 108 from source 110 to target 112 as result data 114.

FES 102 may allow for the data transformation of source data 108 into the result data 114 which is provided from source 110 to target 112 without the use and communications and computing overhead required through the use of the orchestrator 106. For example, FES 102 may allow for direct communications between the data engines 104, which may have been previously unavailable when relying on orchestrator 106. This direct communications of FES increases system throughput while simultaneously reducing the consumption of bandwidth and computing resources, as well as reducing data processing time.

Data engine 104A is illustrative of the organization and configuration of the remaining data engines 104B-D, for simplicity the configuration is only illustrated for data engine 104A. In some embodiments, data engine 104A may include an input 118, one or more actions 116, and an output 120. Input 118 may be the data that is received by the data engine 104A. Action 116, as described above, may be any data manipulation or transformation performed by the data engine 104. In some embodiments, action 116 may include any combination or number of actions, and may affect only a portion of the input 118. Output 120 may be the resultant data after the performance of the action(s) 116.

When orchestrator 106 is being used, the output 120 would be provided back to orchestrator 106. Orchestrator 106 would then provide the output 120 to another data engine 104 as its input 118. However, in FES 102, a data engine 104A has the capability to provide the output 120 directly to another data engine 104B, without first transferring the output 120 to or otherwise communicating with orchestrator 106.

In some embodiments, orchestrator 106 may coordinate the flow of data between the data engines 104 based on a managed flow 122. Managed flow 122 may indicate the data flow between data engines 104A-C. As such, when orchestrator 106 receives output 120 from data engine 104A, orchestrator 106 would then provide the data as input 118 to data engine 104B, in accordance with managed flow 122. The managed flow 122 may include an indication that data goes from source 110 to orchestrator 106 to data engine 104A, back to orchestrator 106 to data engine 104B, back to orchestrator 106, then to data engine 104C, then back to orchestrator 106 which provides the result data 114 to target 112. Managed flow 122 may be configured to have orchestrator 106 in the middle of the communications, and the data engines 104 may have to wait for a communications from orchestrator 106 to begin their relative processing tasks.

FES 102 may generate or receive a component flow 124. Component flow 124 may be a new version of managed flow 122, in which communications with and by orchestrator 106 have been removed. For example, component flow 124 may indicate that data is retrieved by data engine 104A, which transfers its output 120 to data engine 104B, which transfers it output 120a to data engine 104C, which provides its output 120 as the result data 114 to target 112. In some embodiments, component flow 124 may include the network address, network name, internet protocol (IP) address or other identifier of the various data engines 104 involved in the component flow 124.

In some embodiments, when operating in accordance with FES 102, the data engines 104 may be configured with a flow component 126. Flow component 126 may include a compiled or executable portion of code that is configured to understand or read component flow 124. Component flow 124 may include any instructions necessary for a data engine 104 to receive, process, and forward its resultant data to another device or data engine 104. In some embodiments, component flow 124 may include metadata that is passed from data engine 104 to data engine 104. Flow component 126 may be a component that is configured to be able to read the metadata of component flow 124. In some embodiments, flow component 126 may determine a next value 128 from component flow 124.

Next 128 may be an indication as to where the output 120 of a first data engine 104 is to be transferred or provided. Next 128 may include an internet protocol (IP) address, media access control (MAC) address, network name, or other indicator as to where the output 120 from a particular data engine 104 is to be transmit. In some embodiments, data engine 104A may transfer both output 120 and component flow 124 to the device, system, or engine identified next 128.

In some embodiments, flow component 126 may be configured to be operable with the computing language of the underlying data engine 104. In some embodiments, different data engines 104 may be written in or configured to execute different computing languages. As such, flow component 126 may be configured to be operable with the underlying computing language of the data engine 104. For example, while data engines 104A and 104C share the same computing language, and as such may include a similar flow component 126, data engine 126B may include a different computing language and may include a flow component 126 written in its computing language. Flow component 126 may enable each data engine 104 to determine where it is receiving data from and/or providing data to, as may be indicated in component flow 124.

In some embodiments, component flow 124 may include metadata in a single format that is readable by each of the flow components 126, regardless of the computing language of the underlying data engine 104.

As noted above, rather than transferring data back-and-forth between the data engines 104 and orchestrator 106, FES 102 allows for direct communications between data engines 104 via a flow component 126. In some embodiments, the data engines 104 may transfer component flow 124 between one another and the output data 120 or a pointer to the data (as output 120) as stored in a shared memory 130.

In some embodiments, two or more of the data engines 104 may have access to a shared memory component 130. The shared memory 130 may include any data storage location or mechanism that is readable and modifiable by two or more of the data engines 104. In some embodiments, the memory format or the ways in which the data engines read, write, delete, and modify data in memory 130 may be similar, compatible, or identical. Using a shared memory 130, accessible to the data engines 104, may allow for faster communication between data engines 104, because instead of transferring data generated as output 120, the data engines 104 may be able to transfer a pointer to where the output 120 is stored in memory 130.

In some embodiments, an execution agent 134 may initiate the execution, transfer, or processing of data in FES 102. For example, execution agent 134 may receive a request or command to transfer source data 108 to target 112 in accordance with a selected component flow 124. Execution agent 134 may then provide the component flow 124, the source data 108 (or an address or pointer to source data 108), and a message to initiate or begin the transfer and transformation processes to data engine 104A.

Data engine 104A may receive the source data 108 as input 118, perform one or more actions 116, and generate an output 120. Then, flow component 126 may identify the next destination 128 from the component flow 124, and provide the output 120 to the next 128 data engine 104, in accordance with the selected component flow 124.

In some embodiments, execution agent 134 may select or use an alternative flow (alt. flow) 132. Alt. flow 132 may include any data distribution amongst the data engines 104A-D, that is different from the component flow 124. Alt. flow 132 may include the use or processing by a data engine 104D not included in the component flow 124. In some embodiments, the alt. flow 132 may alter, add new, remove, and/or reorder the data engines 104 used in component flow 124. There may be multiple different alt. flows 132. In some embodiments, the alt. flow 132 may include a different sequence in which the same data engines 104 (or a subset of the data engines 104) are used to transform data (relative to the component flow 124).

With the availability of multiple different flows (124, 132), there may different flows of data (e.g., source data 108) streaming through the data engines 104 of FES 102 that are being processed in accordance with the different flows. In some embodiments, the action 116 performed by a particular data engine 104A may be consistent regardless of the flow (124, 132) selected for any received input data 118.

In some embodiments, the data engines 104 may include a status indicator 136. For example, execution agent 134 may ping any of the data engines 104 to discover their current status 136. The status 136 may indicate any variety of status indicators, such as idle, active, paused, an indicator as to which source data 108 or flow 124, 132 is currently active, etc.

There may be times when an engine 104 fails, goes offline, or otherwise becomes unresponsive. For example, a failure may occur at data engine 104B. Then, for example, data engine 104A, may detect a failure in the communication link between data engine 104A and 104B, whereby data engine 104A is unable to communicate with data engine 104B (e.g., receives a bounce back message or fails to receive an acknowledgment message from data engine 104B). Detecting the failure, data engine 104A may suspend or pause its processing, and update its status 136 accordingly. Then, for example, a ping of the status 136 may return pause from engine 104A, idle from data engines 104C and 104D (which are no longer receiving data from data engine 104B), and no response from data engine 104B. Then, for example, execution agent 134 may determine that there is problem or issue with data engine 104B.

Execution agent 134 may then ping or send a message to an administrator or other user regarding the detected failure at data engine 104B. In some embodiments, execution agent 134 may wait a period of time and ping again before notifying a user of the detected failure. Because, for example, some errors may be temporary, and if data engine 104B comes back online, then processing may resume where it left off and the corresponding status 136 of the data engines 104 may be updated without user intervention. However, the detected failure may nonetheless be logged in a failure or processing log by execution agent 134.

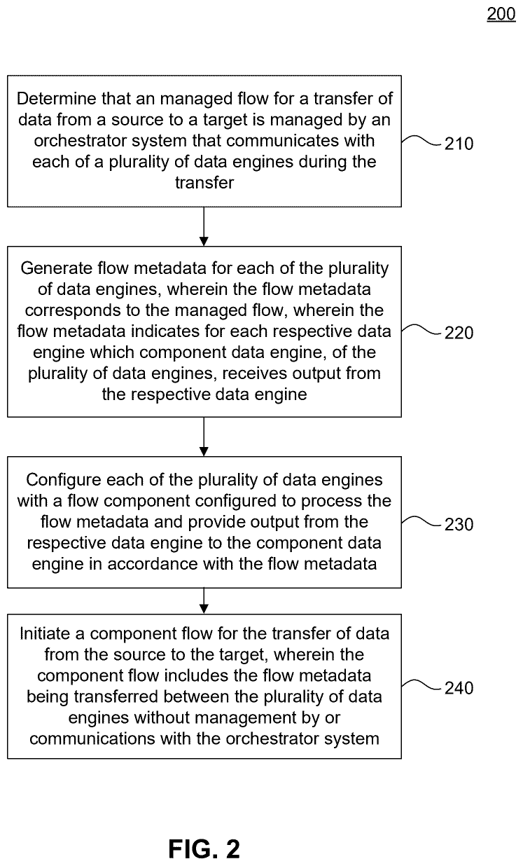

FIG. 2 is a flowchart 200 illustrating example operations for providing a federated execution system (FES) 102, according to some embodiments. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art. Method 200 shall be described with reference to FIG. 1.

In 210, it is determined that an managed flow for a transfer of data from a source to a target is managed by an orchestrator system that communicates with each of a plurality of data engines during the transfer. For example, orchestrator 106 may be configured to manage processing of the data engines 104A-C, based on back-and-forth communications with each of the data engines 104, in accordance with a managed flow 122.

In 220, flow metadata is generated for each of the plurality of data engines, wherein the flow metadata corresponds to the managed flow, wherein the flow metadata indicates for each respective data engine which component data engine, of the plurality of data engines, receives output from the respective data engine. For example, FES 102 may generate, retrieve, or receive component flow 124, which include metadata corresponding to managed flow 122. The component flow 124 may indicate the next destination 128 for each data engine 104. In some embodiments, the component flow 124 may indicate one or more values associated with the expected input 118 or output 120 (e.g., such as data types, the previous engine or device from which the input 118 is being received, etc.)

In 230, each of the plurality of data engines is configured with a flow component configured to process the flow metadata and provide output from the respective data engine to the component data engine in accordance with the flow metadata. For example, engines 104A-D may each be configured with a flow component 126 configured to read the component flow 124 (and alt. flow 132) and determine next 128 from the metadata of the flow (124, 132).

In 240, a component flow for the transfer of data from the source to the target is initiated, wherein the component flow includes the flow metadata being transferred between the plurality of data engines without management by or communications with the orchestrator system. For example, execution agent 134 may provide the component flow 124 to a first data engine 104A to begin the processing of source data 108. In some embodiments, data engine 104A may retrieve the source data 108 and store the data in a memory 130. In other embodiments, execution agent 134 may store the source data 108 in a memory 130 and provide a pointer to the memory address to data engine 104A to begin processing. Then, upon completion of its processing, data engine 104A may provide its output 120 to next 128, and each engine 104 may do the same, until the result data 114 is provided to target 112.

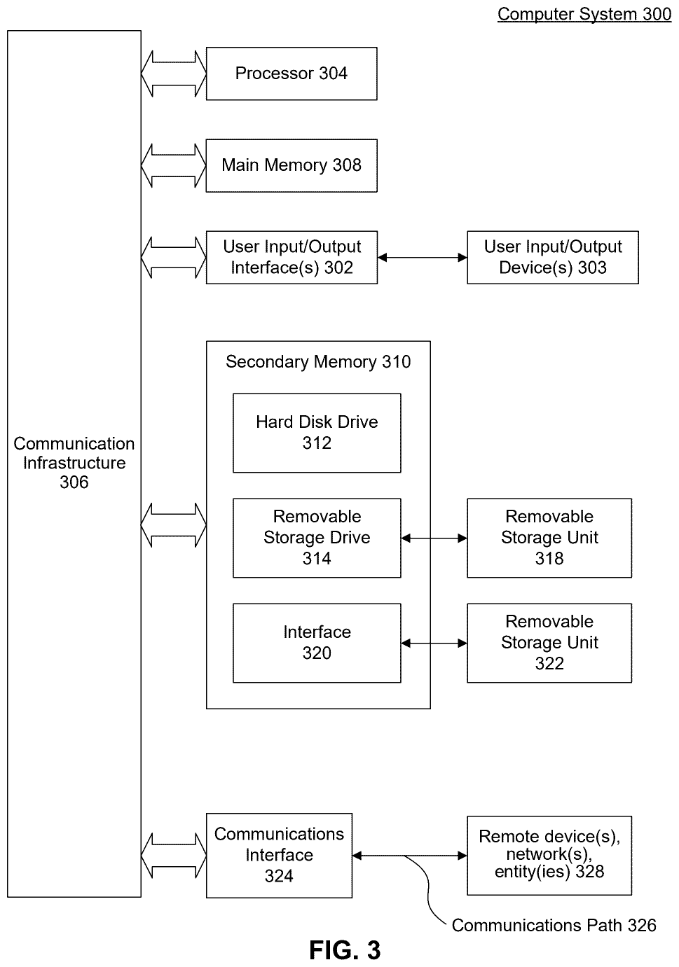

Various embodiments may be implemented, for example, using one or more well-known computer systems, such as computer system 300 shown in FIG. 3. One or more computer systems 300 may be used, for example, to implement any of the embodiments discussed herein, as well as combinations and sub-combinations thereof.

Computer system 300 may include one or more processors (also called central processing units, or CPUs), such as a processor 304. Processor 304 may be connected to a communication infrastructure or bus 306.

Computer system 300 may also include user input/output device(s) 303, such as monitors, keyboards, pointing devices, etc., which may communicate with communication infrastructure 306 through user input/output interface(s) 302.

One or more of processors 304 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 300 may also include a main or primary memory 308, such as random access memory (RAM). Main memory 308 may include one or more levels of cache. Main memory 308 may have stored therein control logic (i.e., computer software) and/or data.

Computer system 300 may also include one or more secondary storage devices or memory 310. Secondary memory 310 may include, for example, a hard disk drive 312 and/or a removable storage device or drive 314. Removable storage drive 314 may be a floppy disk drive, a magnetic tape drive, a compact disk drive, an optical storage device, tape backup device, and/or any other storage device/drive.

Removable storage drive 314 may interact with a removable storage unit 318. Removable storage unit 318 may include a computer usable or readable storage device having stored thereon computer software (control logic) and/or data. Removable storage unit 318 may be a floppy disk, magnetic tape, compact disk, DVD, optical storage disk, and/any other computer data storage device. Removable storage drive 314 may read from and/or write to removable storage unit 318.

Secondary memory 310 may include other means, devices, components, instrumentalities or other approaches for allowing computer programs and/or other instructions and/or data to be accessed by computer system 300. Such means, devices, components, instrumentalities or other approaches may include, for example, a removable storage unit 322 and an interface 320. Examples of the removable storage unit 322 and the interface 320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 300 may further include a communication or network interface 324. Communication interface 324 may enable computer system 300 to communicate and interact with any combination of external devices, external networks, external entities, etc. (individually and collectively referenced by reference number 328). For example, communication interface 324 may allow computer system 300 to communicate with external or remote devices 328 over communications path 326, which may be wired and/or wireless (or a combination thereof), and which may include any combination of LANs, WANs, the Internet, etc. Control logic and/or data may be transmitted to and from computer system 300 via communication path 326.

Computer system 300 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 300, main memory 308, secondary memory 310, and removable storage units 318 and 322, as well as tangible articles of manufacture embodying any combination of the foregoing. Such control logic, when executed by one or more data processing devices (such as computer system 300), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 3. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method comprising:
determining that a managed flow for a transfer of data from a source to a target is managed by an orchestrator system that communicates with each of a plurality of data engines during the transfer, wherein each of the plurality of data engines are configured to perform transformations on the data during the transfer;
generating flow metadata for each of the plurality of data engines, wherein the flow metadata corresponds to the managed flow, wherein the flow metadata indicates for each respective data engine which component data engine, of the plurality of data engines, receives output from the respective data engine;
configuring each of the plurality of data engines with a flow component configured to process the flow metadata and provide output from the respective data engine to the component data engine in accordance with the flow metadata; and
initiating a component flow for the transfer of data from the source to the target, wherein the component flow includes the flow metadata being transferred between the plurality of data engines without management by or communications with the orchestrator system.

2. The method of claim 1, wherein the communications comprise sending and receiving transformed data between the orchestrator system and each of the plurality of data engines.

3. The method of claim 1, further comprising:
identifying an alternate flow for the transfer of data from the source to the target using a different sequence of data flow between the plurality of data engines relative to the component flow; and
initiating the alternate flow of data, different from the component flow and the managed flow, for the transfer of data from the source to the target, wherein the alternate flow is executed without management by or communications with the orchestrator system.

4. The method of claim 1, further comprising:
identifying an alternate flow for the transfer of data from the source to the target using a different subset of the plurality of data engines relative to the component flow; and
initiating the alternate flow of data, different from the component flow and the managed flow, the alternate flow for the transfer of data from the source to the target, wherein the alternate flow is executed without management by or communications with the orchestrator system.

5. The method of claim 1, wherein a first data engine of the plurality of data engines executes a first computing language, wherein a second data engine of the plurality of data engines executes a second computing language, wherein a first flow component for the first data engine is compatible with the first computing language, and wherein a second flow component for the second data engine is compatible with the second computing language.

6. The method of claim 5, wherein the flow metadata is passed from the first data engine to the second data engine, and wherein the first flow component and the second flow component are both configured to process the flow metadata.

7. The method of claim 1, further comprising:
determining, by a first data engine of the plurality of data engines, that a failure has occurred at a second data engine of the plurality of data engines during an execution of the component flow, wherein the first data engine is unable to communicate with the second data engine;
suspending processing of the component flow by the first data engine;
determining, by the first data engine and after the suspending, that communications with the second data engine are available; and
resuming processing of the component flow by the first data engine.

8. A system comprising:
a memory; and
at least one processor coupled to the memory and configured to perform operations comprising:
determining that a managed flow for a transfer of data from a source to a target is managed by an orchestrator system that communicates with each of a plurality of data engines during the transfer, wherein each of the plurality of data engines are configured to perform transformations on the data during the transfer;
generating flow metadata for each of the plurality of data engines, wherein the flow metadata corresponds to the managed flow, wherein the flow metadata indicates for each respective data engine which component data engine, of the plurality of data engines, receives output from the respective data engine;
configuring each of the plurality of data engines with a flow component configured to process the flow metadata and provide output from the respective data engine to the component data engine in accordance with the flow metadata; and
initiating a component flow for the transfer of data from the source to the target, wherein the component flow includes the flow metadata being transferred between the plurality of data engines without management by or communications with the orchestrator system.

9. The system of claim 8, wherein the communications comprise sending and receiving transformed data between the orchestrator system and each of the plurality of data engines.

10. The system of claim 8, the operations further comprising:
identifying an alternate flow for the transfer of data from the source to the target using a different sequence of data flow between the plurality of data engines relative to the component flow; and
initiating the alternate flow of data, different from the component flow and the managed flow, for the transfer of data from the source to the target, wherein the alternate flow is executed without management by or communications with the orchestrator system.

11. The system of claim 8, the operations further comprising:
identifying an alternate flow for the transfer of data from the source to the target using a different subset of the plurality of data engines relative to the component flow; and
initiating the alternate flow of data, different from the component flow and the managed flow, the alternate flow for the transfer of data from the source to the target, wherein the alternate flow is executed without management by or communications with the orchestrator system.

12. The system of claim 8, wherein a first data engine of the plurality of data engines executes a first computing language, wherein a second data engine of the plurality of data engines executes a second computing language, wherein a first flow component for the first data engine is compatible with the first computing language, and wherein a second flow component for the second data engine is compatible with the second computing language.

13. The system of claim 12, wherein the flow metadata is passed from the first data engine to the second data engine, and wherein the first flow component and the second flow component are both configured to process the flow metadata.

14. The system of claim 8, the operations further comprising:
determining, by a first data engine of the plurality of data engines, that a failure has occurred at a second data engine of the plurality of data engines during an execution of the component flow, wherein the first data engine is unable to communicate with the second data engine;
suspending processing of the component flow by the first data engine;
determining, by the first data engine and after the suspending, that communications with the second data engine are available; and
resuming processing of the component flow by the first data engine.

15. A non-transitory computer-readable medium having instructions stored thereon that, when executed by at least one computing device, cause the at least one computing device to perform operations comprising:
determining that a managed flow for a transfer of data from a source to a target is managed by an orchestrator system that communicates with each of a plurality of data engines during the transfer, wherein each of the plurality of data engines are configured to perform transformations on the data during the transfer;
generating flow metadata for each of the plurality of data engines, wherein the flow metadata corresponds to the managed flow, wherein the flow metadata indicates for each respective data engine which component data engine, of the plurality of data engines, receives output from the respective data engine;
configuring each of the plurality of data engines with a flow component configured to process the flow metadata and provide output from the respective data engine to the component data engine in accordance with the flow metadata; and
initiating a component flow for the transfer of data from the source to the target, wherein the component flow includes the flow metadata being transferred between the plurality of data engines without management by or communications with the orchestrator system.

16. The non-transitory computer-readable medium of claim 15, wherein the communications comprise sending and receiving transformed data between the orchestrator system and each of the plurality of data engines.

17. The non-transitory computer-readable medium of claim 15, the operations further comprising:
identifying an alternate flow for the transfer of data from the source to the target using a different sequence of data flow between the plurality of data engines relative to the component flow; and
initiating the alternate flow of data, different from the component flow and the managed flow, for the transfer of data from the source to the target, wherein the alternate flow is executed without management by or communications with the orchestrator system.

18. The non-transitory computer-readable medium of claim 15, the operations further comprising:
identifying an alternate flow for the transfer of data from the source to the target using a different subset of the plurality of data engines relative to the component flow; and
initiating the alternate flow of data, different from the component flow and the managed flow, the alternate flow for the transfer of data from the source to the target, wherein the alternate flow is executed without management by or communications with the orchestrator system.

19. The non-transitory computer-readable medium of claim 15, wherein a first data engine of the plurality of data engines executes a first computing language, wherein a second data engine of the plurality of data engines executes a second computing language, wherein a first flow component for the first data engine is compatible with the first computing language, and wherein a second flow component for the second data engine is compatible with the second computing language.

20. The non-transitory computer-readable medium of claim 19, wherein the flow metadata is passed from the first data engine to the second data engine, and wherein the first flow component and second flow component are both configured to process the flow metadata.
